(19) United States
(12) Patent Application Publication
(10) Pub. No.: US 2022/0166891 A1
(43) Pub. Date: May 26, 2022

(54) INFORMATION PROCESSING APPARATUS, IMAGE PROCESSING APPARATUS, METHOD FOR CONTROLLING INFORMATION PROCESSING APPARATUS, AND RECORDING MEDIUM

(71) Applicant: CANON KABUSHIKI KAISHA, Tokyo (JP)

(72) Inventors: Toru Ikeda, Chiba (JP); Kanta Kumagai, Kanagawa (JP)

(21) Appl. No.: 17/525,102

(22) Filed: Nov. 12, 2021

(30) Foreign Application Priority Data
Nov. 24, 2020 (JP) 2020-194758

(51) Int. Cl. H04N 1/00; G06F 3/0488

(52) U.S. Cl. CPC H04N 1/00392; G06F 2203/04806; G06F 3/04886; H04N 1/00411

(57) ABSTRACT

An application control unit which determines whether a screen displayed on a display is a destination input screen for inputting a destination; and a soft numeric keypad control unit which controls display of a software numeric keypad displayed on the display are provided. When the screen displayed on the display is the destination input screen, the soft numeric keypad control unit causes the software numeric keypad to be displayed in an enlarged manner as compared with when the screen displayed on the display is not the destination input screen.

### BACKGROUND OF THE INVENTION

### Field of the Invention

The present invention relates to an information processing apparatus, an image processing apparatus, a method for controlling an information processing apparatus, and a medium.

### Description of the Related Art

In an image processing apparatus including a scanning function, a printing function, and the like, as an operation unit which receives an operation from a user, a apparatus which includes a touch panel in addition to hardware keys such as a start key have been generally utilized. A start key is a key for performing an image processing apparatus.

On the other hand, for the purpose of cost reduction and design improvement by reducing a size of an operation unit, there is a demand for an image processing apparatus which eliminates a hardware key and enables all inputs to be performed on a touch panel. Japanese Patent Laid-Open No. 2016-226044 discloses a configuration in which an input can be received from a touch panel by displaying, as a software key, a start key which has been provided as a hardware key on a display. Furthermore, Japanese Patent Laid-Open No. 2019-4213 discloses a configuration in which a numeric keypad used for inputting numerical values and an existing screen overlap and are displayed.

However, when a software numeric keypad with an insufficient size is provided relative to a size of a finger, an erroneous operation such as wrong selection on a wrong numeric keypad is likely to occur. As a method for preventing an erroneous operation, a method for playing an enlarged software numeric keypad is also conceivable. However, in the form in which a software numeric keypad and an existing screen are displayed by being overlapped as in Japanese Patent Laid-Open No. 2019-4213, there is a concern concerning all or a part of an existing screen being hidden when displayed due to displaying of an enlarged software numeric keypad.

### SUMMARY OF THE INVENTION

The present invention maintains the operability of operation buttons displayed together with a software numeric keypad while preventing an erroneous operation using a software numeric keypad.

An information processing apparatus of the present invention includes: a determination means which determines whether a screen displayed on a display is a destination input screen for inputting a destination; and a display control means which controls display of a screen of a software numeric keypad displayed on the display unit. When the screen displayed on the display is a destination input screen, the display control means causes the software numeric keypad to be displayed in an enlarged manner as compared with when the screen displayed on a display is not a destination input screen.

Further features of the present invention will become apparent from the following description of exemplary embodiments with reference to the attached drawings.

### BRIEF DESCRIPTION OF THE DRAWINGS

FIG. 1 is a diagram showing a hardware configuration of an information processing apparatus.

FIG. 2 is a diagram showing a software configuration of the information processing apparatus.

FIG. 3 is a diagram showing an example of a home screen.

FIGS. 4A and 4B are diagrams showing an example of a screen of fax applications.

FIGS. 5A and 5B are diagram showing an example of a screen of fax applications.

FIG. 6 is a flowchart for describing a process for changing a size of a soft numeric keypad and displaying the soft numeric keypad depending on whether a screen is for inputting a destination.

FIG. 7 is a diagram showing an example of a table on a destination input screen.

FIG. 8 is a diagram showing an example of a destination input function table.

FIGS. 9A and 9B are examples of a copy function screen.

FIG. 10 is an example of a fax function screen.

FIG. 11 is an example of a setting screen for setting an initial state of a size a soft numeric keypad.

FIG. 12 is a diagram showing an example of a table for managing a setting of an initial state of the soft numeric keypad.

FIG. 13 is a flowchart for describing a process of switching and displaying a size of the soft numeric keypad in accordance with a type of application to start-up.

FIGS. 14A and 14B are diagram for explaining an example of changing a display size of the soft numeric keypad and other operation buttons.

### DESCRIPTION OF THE EMBODIMENTS

### First Embodiment

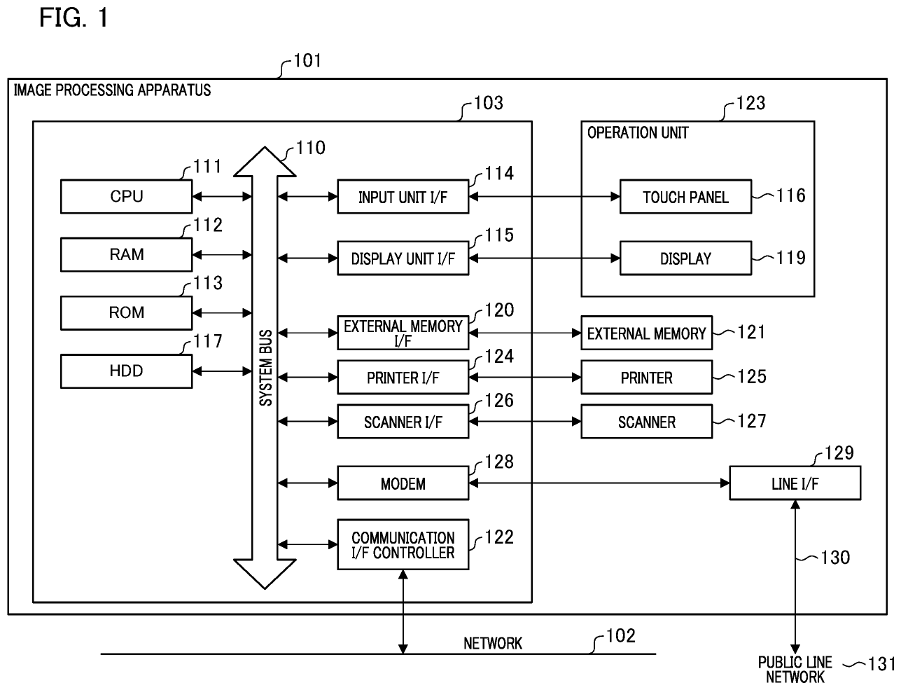

FIG. 1 is a diagram showing a hardware configuration of an information processing apparatus to which each embodiment of the present invention can be applied. As an example of the information processing apparatus, an image processing apparatus 101 will be described as an example. The image processing apparatus 101 includes a control unit 103, an operation unit 123, an external memory 121, a printer 125, a scanner 127, and a line I/F 129. The control unit 103 includes a CPU 111, a RAM 112, a ROM 113, an HDD 117, an input unit I/F 114, a display unit I/F 115, an external memory I/F 120, a communication I/F controller 122, a printer I/F 124, a scanner I/F 126, and a MODEM 128. These are connected to each other via a system bus 110 and data can be exchanged therebetween via the system bus 110. Furthermore, a touch panel 116 is connected to the input unit I/F 114, a display 119 is connected to the display unit I/F 115, and the external memory 121 is connected to the external memory I/F 120. In addition, the printer 125 is connected to the printer I/F 124, the scanner 127 is connected to the scanner I/F 126, and the line I/F 129 is connected to the MODEM 128. Each unit connected to the system bus 110 is configured so that data can be exchanged therebetween via the system bus 110.

The ROM 113 is a non-volatile memory and image data, other data, various programs for operating the CPU 111, and the like are stored in prescribed regions. The RAM 112 is a volatile memory and is used as a transitory storage region for a main memory, a work area, and the like of the CPU 111. Furthermore, the RAM 112 is also used as a storage region for holding screen display information. The HDD 117 is a readable and writable non-volatile storage apparatus and stores various data such as a program for controlling the entire image processing apparatus 101, various application programs, and setting information. The CPU 111 controls each unit of the image processing apparatus 101 using the RAM 112 as a work memory in accordance with a program stored in the ROM 113, the HDD 117, or the external memory 121.

The operation unit 123 is an interface for allowing the user to operate the image processing apparatus 101 via the input unit I/F 114 and the display unit I/F 115. The operation unit 123 is composed of, for example, a combination of the touch panel 116 and the display 119. When input coordinates in the touch panel 116 are associated with display coordinates, it is possible to configure a graphical user interface (GUI) as if the user were directly performing operations on a screen displayed in the touch panel 116. The user provides an instruction such as a job execution instruction to the image processing apparatus 101 on a user interface screen displayed in the touch panel 116 as an input device which receives a user's operation.

The input unit I/F 114 receives an operation from the user, generates a control signal according to the operation, and supplies the control signal to the CPU 111. For example, the input unit I/F 114 includes a device such as operation buttons and a keyboard for inputting character information and providing an instruction for processing execution and a pointing device such as a mouse and a touch panel 116.

The touch panel 116 is, for example, an input device configured in a plane which outputs coordinate information according to a position in contact with an input unit. The CPU 111 controls each unit of the image processing apparatus 101 according to a program on the basis of a control signal generated and supplied using the input unit I/F 114 in response to the user's operation performed on the input device. Thus, it is possible to perform an operation according to the user's operation on the image processing apparatus 101. This may be replaced by a mouse (not shown).

The display unit I/F 115 outputs a display signal for displaying an image on the display 119. The CPU 111 supplies a display control signal generated according to a program to the display unit I/F 115. The display unit I/F 115 causes the display 119 to display a GUI screen constituting a GUI on the basis of this display control signal.

In the embodiment, the touch panel 116 is integrally configured with the display 119. The touch panel 116 is configured so that the light transmittance does not interfere with the display of the display 119 and is attached to an upper layer of a display surface of the display 119. Moreover, the CPU 111 associates the input coordinates in the touch panel 116 with the display coordinates on the display 119. Thus, it is possible to configure a GUI as if the user were directly performing operations on a screen displayed on the display 119.

For example, the external memory 121 such as a hard disk, a floppy disk, a CD, a DVD, a USB, or a memory card can be attached to the external memory I/F 120. The external memory I/F 120 reads data from the attached external memory 121 and writes data to the external memory 121 on the basis of the control of the CPU 111.

The image processing apparatus 101 is connected to a network 102 via the communication I/F controller 122. The communication I/F controller 122 communicates with the network 102 on the basis of the control of the CPU 111. The network 102 is, for example, a so-called communication network such as the Internet realized using any one or a combination of a LAN, a WAN, a telephone line, a dedicated digital line, a cable television line, a wireless line for data broadcasting, and the like.

The printer I/F 124 is an interface for connecting the printer 125 and the system bus 110. Image data to be printed by the printer 125 such as print data received from the outside via the network 102 is transferred from the system bus 110 via the printer I/F 124 and printed on a recording medium (paper) in the printer 125.

The scanner I/F 126 is an interface for connecting the scanner 127 and the system bus 110. The scanner 127 reads an image on a document, generates image data, and inputs the image data to the system bus 110 via the scanner I/F 126.

The MODEM 128 is connected to a public line network 131 via the line I/F 129 and performs communication processing with other external apparatuses such as another image processing apparatus, a facsimile apparatus, and a telephone (which are not shown). The line I/F 129 and the public line network 131 are generally connected using a telephone line 130 or the like.

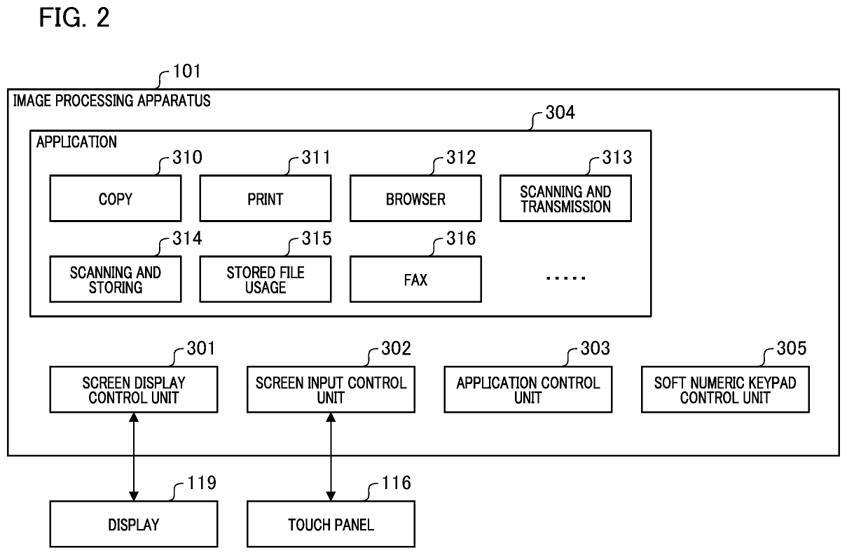

FIG. 2 is a diagram showing a software configuration of an information processing apparatus to which each embodiment of the present invention can be applied. In the embodiment, an illustrated software module is realized by controlling, by the CPU 111, the RAM 112, the ROM 113, the input unit I/F 114, the display unit I/F 115, the printer L/F 124, and the scanner I/F 126.

The image processing apparatus 101 includes applications 304, a screen display control unit 301, a screen input control unit 302, an application control unit 303, and a soft numeric keypad control unit 305. The screen display control unit 301 manages a screen of the entire application. To be specific, the screen display control unit 301 mainly performs a process of transferring screen information to the display 119 and a process of notifying an application of an event input from the touch panel 116. The son numeric keypad control unit 305 controls the display of a software numeric keypad (hereinafter referred to as a “soft numeric keypad”) on the display 119. The screen display control unit 301 and the soft numeric keypad control unit 305 function as display control means.

The screen input control unit 302 converts an operation from the touch panel 116 into an input signal in the input unit I/F 114, receives and analyzes the input signal, and converts the input signal into an event format which can be transmitted to the application. Moreover, the screen input control unit 302 notifies the screen display control unit 301 of the input signal. The application control unit 303 causes the starting-up and switching of the applications 304 which will be describer later to be performed in response to an input from the touch panel 116. Furthermore, the application control unit 303 displays the applications 304 on the display 119 via the screen display control unit 301.

The applications 304 are a group of applications which operate on the image processing apparatus 101. The CPU 111 operates each of the applications in accordance with an instruction from a user via the screen input control unit 302. Among the applications 304 included in the image processing apparatus 101, typical applications are as follows:
a copy function 310 which reads an image on a document using the scanner 127 and prints the generated image data using the printer 125;
a printing function 311 which prints image data using the printer 125 on the basis of a print job input from an external apparatus such as a PC;
a scanning and transmission function 313 which reads an image on a document using the scanner 127 and transmits the generated image data to the outside via the communication I/F controller 122;
a scanning and storing function 314 which reads an image on a document using the scanner 127 and stores the generated image data in the external memory 121;
a fax function 316 which reads an image on a document using the scanner 127 and transmits the generated image data to the outside via the MODEM 128 or the line I/F 129;
a stored file using function 315 which prints image data stored in the external memory 121 using the printer 125 or transmits the image data to the outside via the communication I/F controller 122; and
a browser function 312 which browses, prints, and stores data on a web server via a web browser.

The applications included in the image processing apparatus 101 are not limited to the applications described above and applications can be added later.

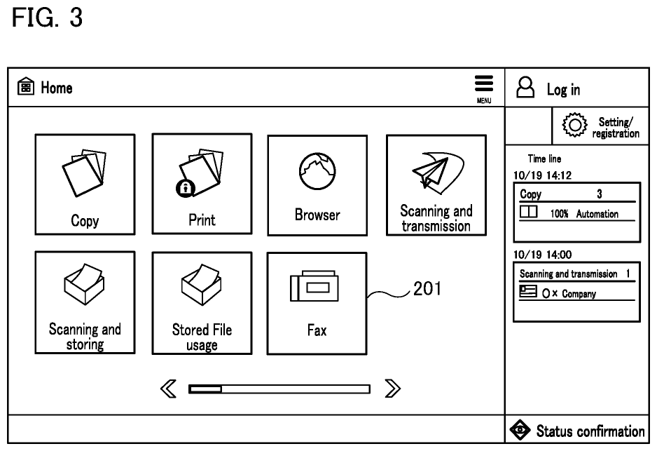

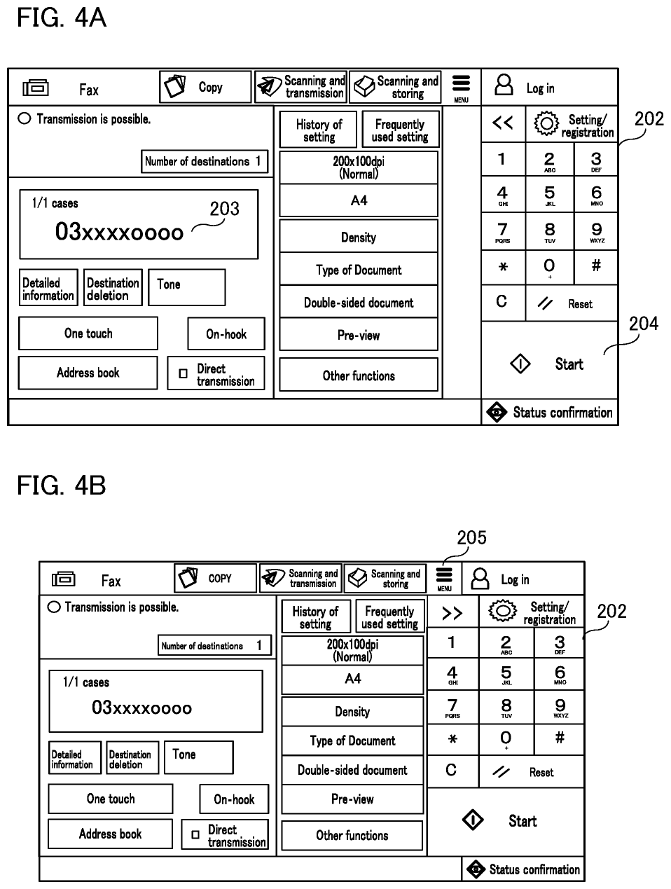

FIGS. 3 to 5B are examples of screens displayed on the display 119. FIG. 3 is a diagram showing an example of a home screen for selecting any of the applications 304 of the image processing apparatus 101. For example, a button (icon) for selecting an application, a log-in button, a setting button, a timeline for displaying the latest operating status of the image processing apparatus 101, and the like are displayed on the home screen. A fax button 201 is a button for calling an application for the fax function 316. If the screen input control unit 302 detects that a user presses the fax button 201, the screen display control unit 301 causes a screen to transition to the screen shown in FIG. 4A.

FIG. 4A is a diagram showing an example of a screen for the fax application. For example, a setting button for making various fax settings, a set value, a soft numeric keypad 202, a start key 204, and the like are displayed in the screen for the fax application. The soft numeric keypad 202 is a numeric keypad used at the time of inputting a numerical value. If the soft numeric keypad 202 is pressed, a number input through the pressing of the soft numeric keypad 202 by a user is input to a fax number 203. If the start key 204 is pressed in a state in which a fax number of a fax transmission destination has been input to the fax number 203, the image data generated through the reading using the scanner 127 is transmitted to the destination of the fax number 203 via the MODEM 128 and the line I/F 129.

Here, depending on a size of the user's finger, the display of the soft numeric keypad 202 having a sufficient size is unlikely to be provided and an erroneous setting or an erroneous operation of the destination is likely to occur due to an erroneous pressing of the soft numeric keypad 202.

FIG. 4B is a diagram showing an example of a screen of a fax application as in FIG. 4A. FIG. 4B shows the enlarged soft numeric keypad 202 larger than that in FIG. 4A. In this way, when the enlarged soft numeric keypad 202 is displayed on a screen configured to input a fax destination, it is possible to minimize erroneous pressing. Furthermore, in the example of FIGS. 4A and 4B, a blank region is provided between the soft numeric keypad 202 which had not been subjected to the enlargement and other operation buttons, as shown in FIG. 4A, so that the enlarged soft numeric keypad 202 and other operation buttons do not overlap when the enlarged soft numeric keypad 202 is displayed.

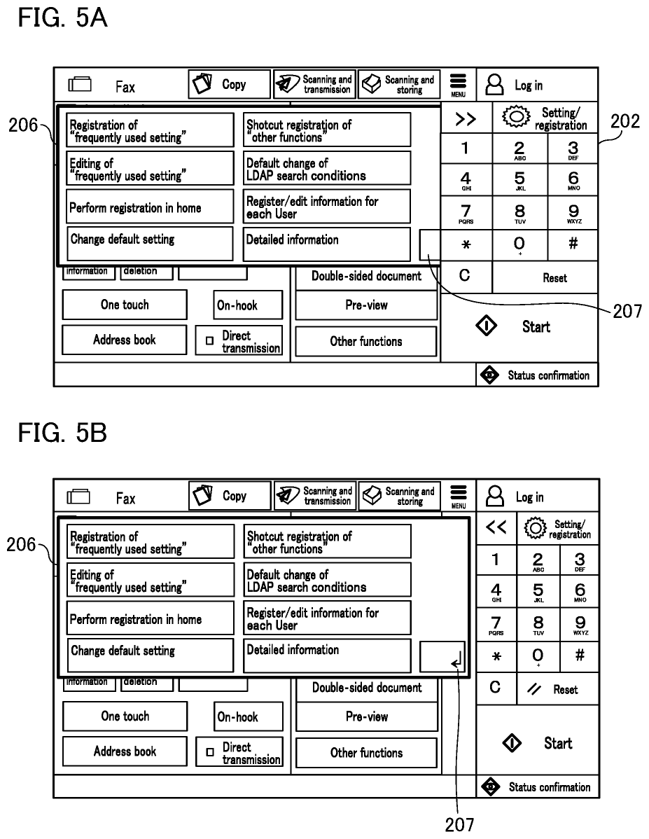

FIG. 5A is a diagram showing an example of a screen on which a pop-up 206 is displayed in the screen of fax applications. For example, if a menu 205 is pressed in the screen shown in FIG. 4B, the pop up 206 is displayed. The pop up 206 is a group of buttons for setting functions associated with a fax. A back button 207 is a button for closing the display of the pop up 206 and performing transitioning to the screen shown in FIG. 4B in which the pop up 206 is not open.

Here, if the enlarged soft numeric keypad 202 is displayed as shown in FIG. 5A, the soft numeric keypad 202 covers the back button 207, in which the presence of the back button 207 is unlikely to be noticed. Furthermore, even when a user notices the presence of the back button 207, the user may press the soft numeric keypad 202 by mistake when attempting to press the back button 207, resulting in the user making an erroneous operation.

FIG. 5B is a diagram showing an example of a screen in which the pop up 206 is displayed in the screen of fax applications. The downscaled soft numeric keypad 202 shown in FIG. 5B is displayed smaller than the soft numeric keypad 202 shown in FIG. 5A and the back button 207 of the pop up 206 and the soft numeric keypad 202 do not overlap. For this reason, there is no concern of a user not noticing the presence of the back button 207 and thus pressing the soft numeric keypad 202 by mistake rather than the back button 207.

In this way, when the enlarged soft numeric keypad 202 is displayed in the screen in which a destination is input (FIG. 4B), that is, the screen in which the soft numeric keypad 202 is used, it is possible to prevent an erroneous operation. On the other hand, when the downscaled soft numeric keypad 202 is displayed in the screen in which a destination is not input (FIG. 5B), that is, the screen in which the soft numeric keypad 202 is not used, the soft numeric keypad 202 allows the function to be set without interfering with other operations.

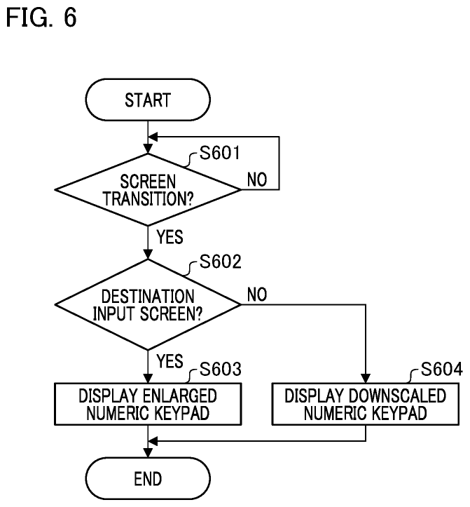

A process for realizing a form in which displaying is performed so that a screen in which other operations are received and the soft numeric keypad 202 do not overlap in the screen in which the soft numeric keypad 202 is not used without displaying the enlarged soft numeric keypad 202 will be described with reference to FIG. 6. FIG. 6 is a flowchart for describing a process of changing a size of the soft numeric keypad 202 and displaying the soft numeric keypad 202 depending on whether the screen is for inputting a destination. Each process shown in the flowchart of FIG. 6 is realized using the CPU 111 of the image processing apparatus 101 which reads a control program stored in the ROM 113 or the external memory 121 into the RAM 112 and executes the control program. When the CPU 111 detects the starting-up of the image processing apparatus 101, this flow is started.

In Step S601, the application control unit 303 determines whether a screen has transitioned to a setting screen of applications 304. The application control unit 303 determines the transitioning of a screen to the setting screen of the applications 304 depending on whether a user's input operation received by the screen input control unit 302 via the touch panel 116 is an instruction to display the setting screen of the applications 304. When an operation is transitioning to the setting screen of the applications 304, the process proceeds to the process of Step S602. On the other hand, when an operation is not transitioning to the setting screen of the applications 304, Step S601 is repeatedly performed.

The transition of the screen will be described using a fax which is one of the applications 304 as an example. The application control unit 303 determines that an operation is transitioning of a screen to the setting screen of the applications 304 when the user's input operation received via the touch panel 116 is pressing of the fax button 201 in the home screen (FIG. 3). Furthermore, the screen input control unit 302 determines that an operation is transitioning of a screen to the setting screen of the applications 304 also when a user's input operation is transitioning of a screen in the setting screen of the applications 304 such as pressing of the menu 205 for displaying the pop up 206.

In Step S602, the application control unit 303 determines whether a screen to transition from is a screen for inputting a destination (hereinafter also referred to as a “destination input screen”). When the screen to transition from is a screen for inputting a destination, the process proceeds to the process of Step S603. On the other hand, when a screen to transition from is not a screen for inputting a destination, the process proceeds to the process of Step S604.

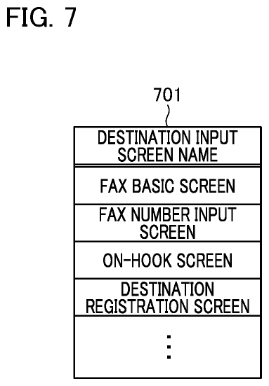

A method of determining whether a screen to transition is a destination input screen will be described. For example, the application control unit 303 determines whether the screen to transition is the destination input screen with reference to a destination input screen table 701 shown in FIG. 7 depending on the screen to transition is present in the destination input screen table 701. FIG. 7 is a diagram showing an example of the destination input screen table. The destination input screen table 701 is stored in the RAM 112. The destination input screen table 701 is a list of screens displayed at the time of inputting a destination. As the screens displayed at the time of inputting a destination, for example, a fax basic screen, a fax number input screen, and the like are stored in the destination input screen table 701. The application control unit 303 determines that the screen to transition is the destination input screen when the transitioning to a screen shown in the destination input screen table 701 is performed.

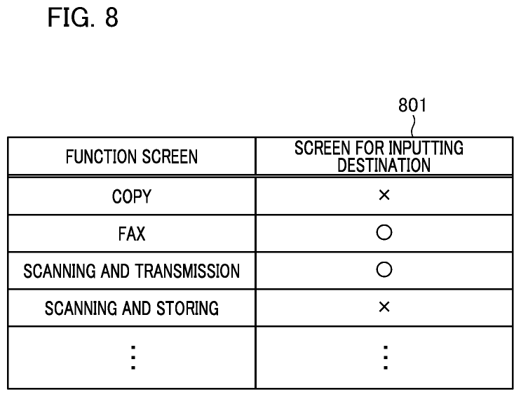

Also, the application control unit 303 may determine whether the screen to transition is the destination input screen with reference to a destination input application table 801 shown in FIG. 8 depending on whether the screen to transition is present in the destination input application table 801. FIG. 8 is a diagram showing an example of the destination input application table. The destination input application table 801 is stored in the RAM 112. The destination input application table 801 is a table in which each function screen (application screen) is associated with information indicating that the screen is a screen configured to input a destination. The function screen shows the functions of each application such as “copy” and “fax.” In the destination input application table 801, each function screen, that is, each application screen, is associated with a screen configured to input a destination and the association is stored. For example, it is determined in Step S602 that a “fax” function screen and a “scanning and transmitting” function screen in which “∘” is provided with respect to a “screen for inputting a destination” is the destination input screen.

When the screen to transition is the destination input screen, in Step S603, the soft numeric keypad control unit 305 causes the soft numeric keypad 202 to be enlarged and displays the enlarged soft numeric keypad 202 on the display 119.

On the other hand, when the screen to transition is not the destination input screen, in Step S604, the soft numeric keypad control unit 305 causes the soft numeric keypad 202 to be downscaled and displays the downscaled soft numeric keypad 202 (or the soft numeric keypad 202 having a normal size) on the display 119.

Although it is determined in Step S601 that the transitioning of a screen to the setting screen of the applications 304 is performed, the present invention is not limited thereto. In addition, it may be determined whether the transitioning of a screen to the screen displayed on the display 119 is performed. At this time, it is determined in Step S602 whether the screen displayed on the display 119 is the destination input screen.

Also, although it is determined in Step S602 whether the screen is for inputting a destination, the present invention is not limited thereto. In addition, other determination methods such as whether the screen uses the software numeric keypad may be used.

Although the form of performing displaying without performing enlargement so that the screen in which other operations are received and the soft numeric keypad 202 do not overlap in the screen in which a destination is not input, that is, the screen in which the soft numeric keypad 202 is not used has been described with reference to FIGS. 4A to 6, the present invention is not limited thereto. In order to prevent the soft numeric keypad 202 from interfering with other operations such as the pop up 206, for example, the soft numeric keypad 202 may not be displayed on a screen in which the soft numeric keypad 202 is not used. That is to say, an example in which the downscaled soft numeric keypad 202 or the soft numeric keypad 202 having a normal size is displayed has been described. In Step S604, the soft numeric keypad 202 may not be displayed.

As described above, when the enlarged soft numeric keypad 202 is displayed in the screen in which a destination is input, it is possible to prevent an erroneous operation. On the other hand, when the soft numeric keypad 202 smaller than that at the time of the enlarged soft numeric keypad 202 is displayed or is not displayed in the screen in which a destination is not input, the soft numeric keypad 202 allows the function to be set without interfering with other operations.

### Second Embodiment

In the first embodiment, the enlarged soft numeric keypad 202 is automatically displayed in the screen in which a destination is input and the downscaled soft numeric keypad 202 is automatically displayed in the screen in which a destination is not input. In the embodiment, a configuration in which a user can set whether the enlarged soft numeric keypad 202 is displayed in accordance with a type of application will be described. Differences between the second embodiment and the first embodiment will be mainly described below.

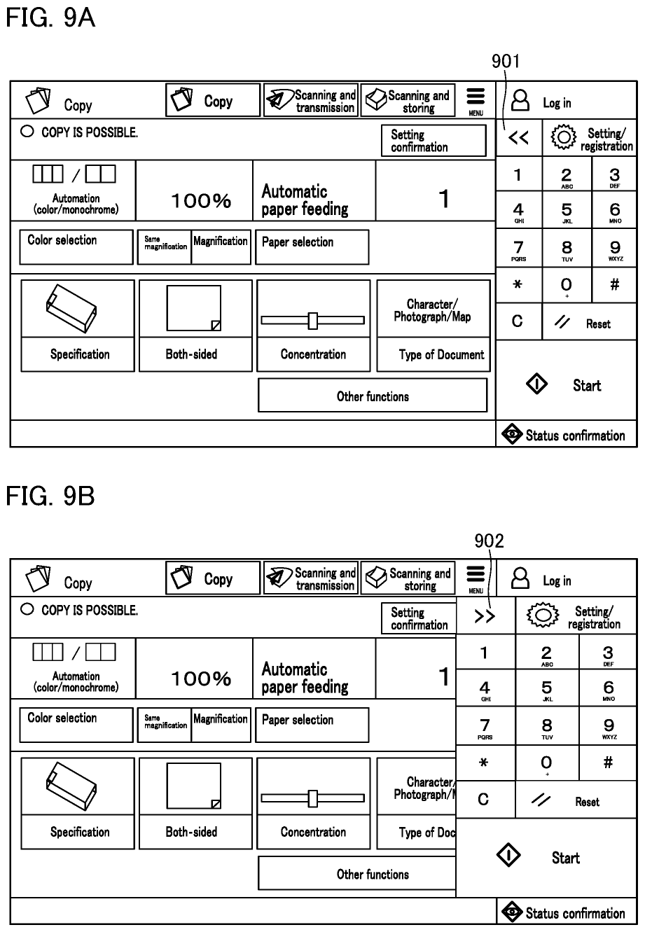

For example, setting is provided so that the enlarged soft numeric keypad 202 is not displayed in copying and setting is provided so that the enlarged soft numeric keypad 202 is displayed in a fax in which a destination is input. FIGS. 9A and 9B are an example of a copy function screen. FIG. 9A is an example of a copy function screen displayed when a copy application starts up. Since setting is provided so that the enlarged soft numeric keypad 202 is not displayed in copying, in FIG. 9A, the downscaled soft numeric keypad 202 is displayed (downscaled state or normal display). An enlargement button 901 for displaying the enlarged soft numeric keypad 202 is displayed on the soft numeric keypad 202 displayed in a small state. When a user presses the enlargement button 901, as shown in FIG. 9B, the enlarged soft numeric keypad 202 is displayed. A reduction button 902 for displaying (or normally displaying) the soft numeric keypad 202 in a downscaled manner on the soft numeric keypad 202 is displayed in an enlarged manner.

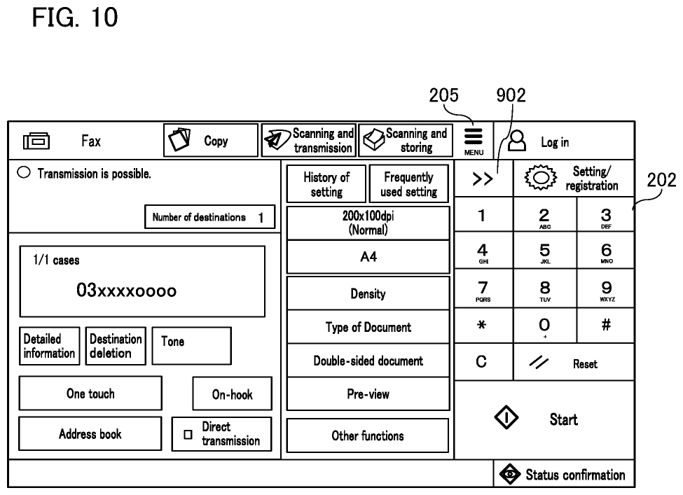

FIG. 10 is an example of a fax function screen displayed when a fax application starts up. Since setting is provided so that the enlarged soft numeric keypad 202 is displayed in a fax, the enlarged soft numeric keypad 202 is displayed. The reduction button 902 for displaying (or normally displaying) the soft numeric keypad 202 in a downscaled manner on the soft numeric keypad 202 is displayed in an enlarged manner.

When a size of default display of the soft numeric keypad 202 is switched in accordance with a type of application starting-up in this way, it is possible to display only an application having a high input frequency of the soft numeric keypad 202 in an enlarged state. Furthermore, the enlargement button 901 or the reduction button 902 which is a switching button for switching a display size of the software numeric keypad in accordance with a user's instruction can switch a display size of the soft numeric keypad 202 which has been displayed in accordance with a user's instruction.

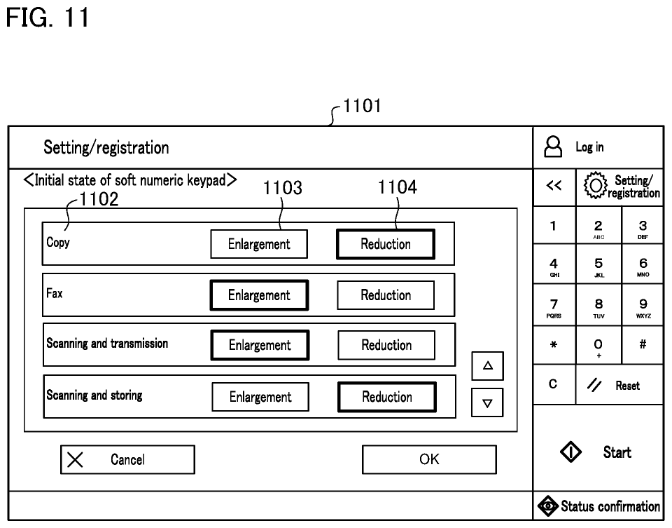

FIG. 11 is a diagram showing an example of a setting screen for setting an initial state of a size of the soft numeric keypad 202 in accordance with a type of application to start up. A screen for selecting displaying of the soft numeric keypad 202 having an enlarged initial state or displaying of the soft numeric keypad 202 having a downscaled initial state for each application is displayed in an initial state setting screen 1101. When the application starts up, the soft numeric keypad 202 is displayed in an initial state set in the initial state setting screen 1101. For example, in a copy function 1102, when a reduction button 1104 of an enlargement button 1103 and the reduction button 1104 is selected and a copy application starts up, setting is provided so that the downscaled soft numeric keypad 202 is displayed. The initial state setting screen 1101 may be displayed only when a user logged-in to the image processing apparatus 101 has an administrator authority or may be displayed for each user.

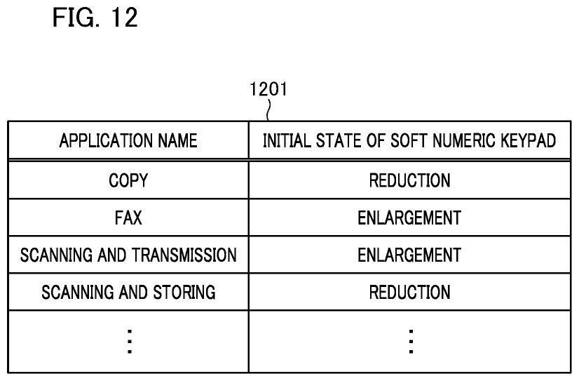

Set values set in the initial state setting screen 1101 are stored in an initial state setting table 1201 shown in FIG. 12. FIG. 12 is a diagram showing an example a table configured to manage the setting of the initial state of the soft numeric keypad when the application starts up. The initial state setting table 1201 is stored in the RAM 112. The initial state setting table 1201 stores the association obtained by associating initial application names with initial states of the soft numeric keypad 202 set in the initial state setting screen 1101. The initial state of the soft numeric keypad 202 is updated in accordance with the setting details of the initial state setting screen 1101.

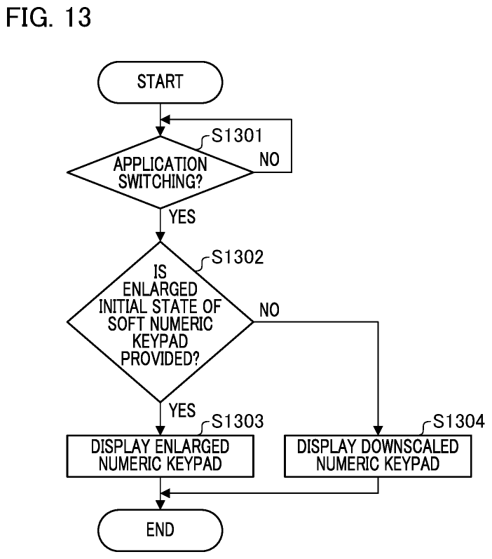

FIG. 13 is a flowchart for describing a process of switching and displaying a size of the soft numeric keypad 202 in accordance with a type of application to start up in the second embodiment. Each operation shown in the flowchart of FIG. 13 is realized using the CPU 111 of the image processing apparatus 101 which reads a control program stored in the ROM 113 or the external memory 121 into the RAM 112 and executes the control program. When the CPU 111 detects the starting-up of the image processing apparatus 101, this flow starts up.

In Step S1301, the application control unit 303 determines whether the screen input control unit 302 has received an instruction from a user to switch the application 304 via the touch panel 116. For example, when a button for starting up the applications 304 such as the fax button 201 is pressed in a state in which the screen of FIG. 3 is displayed, it is determined that the instruction for performing the switching of the applications 304 has been received. When the instruction for performing the switching of the applications 304 has been received, the process proceeds to the process of Step S1302. On the other hand, when the instruction for performing the switching of the applications 304 has not been received. Step S1301 is repeatedly performed.

In Step S1302, the soft numeric keypad control unit 305 determines whether the initial state of the soft numeric keypad 202 of the applications 304 which has received an instruction for performing the switching in Step S1301 is an enlarged state. To be specific, the soft numeric keypad control unit 305 determines whether the initial state of the soft numeric keypad 202 corresponding to the applications 304 which has received an instruction for performing the switching in Step S1301 is an enlarged state with reference to the initial state setting table 1201. When the initial state of the soft numeric keypad 202 of the applications 304 which has received an instruction for performing the switching is an enlarged state, the process proceeds to the process of Step S1303. On the other hand, when the initial state of the soft numeric keypad 202 of the applications 304 which has received an instruction for performing the switching is not an enlarged state, the process proceeds to the process of Step S1304.

When the initial state of the soft numeric keypad 202 of the applications 304 to be displayed is not an enlarged state, in Step S1303, the soft numeric keypad control unit 305 causes the enlarged soft numeric keypad 202 to be displayed on the display 119.

When the initial state of the soft numeric keypad 202 of the applications 304 to be displayed is an enlarged state, in Step S1304, the soft numeric keypad control unit 305 causes the downscaled soft numeric keypad 202 to be displayed on the display 119.

An initial state setting of the soft numeric keypad 202 may be maintained for each user to be authenticated. Furthermore, although a user sets the initial state of the soft numeric keypad 202 in the second embodiment, the initial state of the soft numeric keypad 202 may be set in advance for each application at the time of shipment. In addition, although an example in which a display size of the soft numeric keypad 202 is switched in accordance with a type of application to start up has been described, in an application having a low frequency of use of the soft numeric keypad 202, the soft numeric keypad 202 may be set not to be displayed.

Also, the input frequency of the soft numeric keypad 202 may be stored and the initial state of the soft numeric keypad 202 may be switched in accordance with this frequency. For example, the number of times the soft numeric keypad 202 is pressed is counted for each application 304 and stored in the RAM 112. Only when the number of times the soft numeric keypad 202 is pressed for each stored application 304 is equal to or greater than a threshold value, the soft numeric keypad 202 is displayed in an enlarged state when the application 304 starts up.

As described above, when the display size of the soft numeric keypad 202 is switched in accordance with a type of application to start up, the enlarged soft numeric keypad 202 can be displayed from the time of starting-up only in a specific application in which a high input frequency of the soft numeric keypad 202 is provided. Thus, in addition to preventing an erroneous operation of the soft numeric keypad 202, it is possible to set other functions without being hindered by the soft numeric keypad 202 in an application in which a low input frequency of the soft numeric keypad 202 is provided.

### Third Embodiment

In the first embodiment and the second embodiment, an example in which only the enlarged soft numeric keypad 202 or the downscaled soft numeric keypad 202 among the soft numeric keypad 202 and other operation buttons is displayed has been described. In this embodiment, an example in which an enlarged display region or a downscaled display region of other operation buttons is provided in accordance with a size in which the soft numeric keypad 202 is displayed will be described.

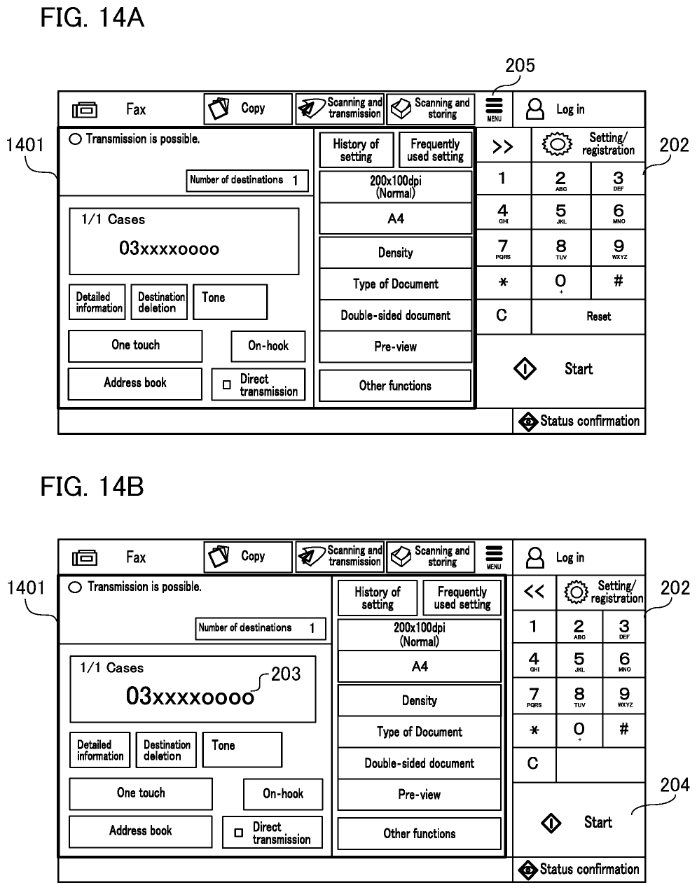

FIGS. 14A and 14B are diagram for explaining an example in which display sizes of the soft numeric keypad 202 and other operation buttons are changed. FIG. 14A shows a soft numeric keypad 202 displayed in an enlarged manner. A screen display control unit 301 causes an operation button region 1401 which is a region in which other operation buttons to be displayed in a downscaled manner so that the soft numeric keypad 202 displayed in an enlarged manner and the operation button region 1401 do not overlap. For example, the screen display control unit 301 causes the operation button region 1401 to be displayed in a downscaled manner in addition to a process of displaying the enlarged soft numeric keypad 202 in Step S603 and Step S803. In FIG. 14B, the soft numeric keypad 202 is normally displayed (or displayed in a downscaled manner). The screen display control unit 301 causes the enlarged operation button region 1401 to be displayed as compared with the example of FIG. 14A within a range in which the operation button region 1401 and the soft numeric keypad 202 do not overlap. For example, the screen display control unit 301 causes the operation button region 1401 to be displayed in an enlarged manner in addition to a process of displaying the soft numeric keypad 202 in a downscaled manner in Step S604 and Step S804.

As described above, according to this embodiment, it is possible to change a display size of other operation buttons in accordance with a display size of the soft numeric keypad 202. Thus, it is possible to prevent the soft numeric keypad 202 and other operation buttons from overlapping each other and making it difficult for a user to operate.

Although the image processing apparatus 101 having a plurality of functions such as a copy function and a scanner function has been described as an example in the embodiments, the present invention is also applicable to an image processing apparatus having only some of the functions. Furthermore, the present invention may be applied to other information processing devices such as personal computers, PDAs, mobile phones, fax machines, cameras, video cameras, and other image viewers.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory apparatus, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-194758, filed Nov. 24, 2020, which is hereby incorporated by reference wherein in its entirety.

What is claimed is:

1. An information processing apparatus comprising:
at least one memory storing instructions; and
one or more processors configured to execute the instructions, which when executed by the one or more processors, cause the information processing apparatus to:
determine whether a screen displayed on a display unit is a destination input screen for inputting a destination; and
control display of a screen including a software numeric keypad displayed on the display unit;
wherein, when the screen displayed on the display unit is a destination input screen, an enlarged software numeric keypad is displayed as compared with when the screen displayed on the display unit is not a destination input screen.

2. The information processing apparatus according to claim 1, wherein, when the screen displayed on the display unit is not a destination input screen, a downscaled software numeric keypad is displayed as compared with when the screen displayed on the display unit is a destination input screen, or the software numeric keypad is not displayed.

3. The information processing apparatus according to claim 1, wherein, when the screen displayed on the display unit is included in a destination input screen table, it is determined that the screen is a destination input screen.

4. The information processing apparatus according to claim 1, wherein, when the screen displayed on the display unit is a screen of an application for inputting a destination, it is determined that the screen is a destination input screen.

5. The information processing apparatus according to claim 1, wherein the instructions cause the information processing apparatus to set an initial state of display of a software numeric keypad for each application,
wherein a display size of the software numeric keypad is set as the initial state of the display of the software numeric keypad, and
wherein, when the application starts up, display of the software numeric keypad is controlled in accordance with the set initial state.

6. The information processing apparatus according to claim 5, wherein the initial state is set in accordance with an instruction received from a user.

7. The information processing apparatus according to claim 5, wherein the initial state is set in accordance with a frequency of use of the software numeric keypad for each application, and when the frequency of use of the software numeric keypad is more than a threshold value, the initial state of display of the software numeric keypad is set to be displayed in an enlarged manner.

8. The information processing apparatus according to claim 1, wherein a switching button which receives a user's instruction to switch a display size of the software numeric keypad is displayed in a screen in which the software numeric keypad is displayed.

9. The information processing apparatus according to claim 1, wherein display of operation buttons other than the software numeric keypad is controlled so that the software numeric keypad and the other operation buttons do not overlap in accordance with the display size of the software numeric keypad.

10. The information processing apparatus according to claim 1, wherein the information processing apparatus has a fax function, and
the destination input screen includes a screen for inputting a fax destination.

11. An image processing apparatus comprising:
at least one memory storing instructions; and
one or more processors configured to execute the instructions, which when executed by the one or more processors, cause the image processing apparatus to:
determine whether a screen displayed on a display unit is a destination input screen for inputting a destination; and
control display of a screen including a software numeric keypad displayed on the display unit;
wherein, when the screen display on the display unit is the destination input screen, the enlarged software numeric keypad is displayed as compared with when the screen display on the display unit is not the destination input screen.

12. A method for controlling a software numeric keypad, the method comprising:
determining whether a screen displayed on a display unit is a destination input screen for inputting a destination; and
controlling display of a screen including a software numeric keypad displayed on the display unit,
wherein, when the screen displayed on the display unit is the destination input screen, the enlarged software numeric keypad is displayed as compared with when the screen displayed on the display unit is not the destination input screen.

13. A non-transitory storage medium storing instructions that when executed by one or more processors controls the one or more processors to operate as:
determining whether a screen displayed on a display unit is a destination input screen for inputting a destination; and
controlling display of a screen including a software numeric keypad displayed on the display unit,
wherein, when the screen displayed on the display unit is the destination input screen, the enlarged software numeric keypad is displayed as compared with when the screen displayed on the display unit is not the destination input screen.
